(19) United States
(12) Patent Application Publication
(10) Pub. No.: US 2008/0072237 A1
(43) Pub. Date: Mar. 20, 2008

(54) Navigating Applications in an Interactive Computing Device

(76) Inventors: Mats Hellman, Karlskrona (SE); Jessica Svensson, Karlskrona (SE)

Correspondence Address: HARRITY SNYDER, L.L.P., 11350 RANDOM HILLS ROAD, SUITE 600, FAIRFAX, VA, 22030, US

(21) Appl. No.: 11/576,647

(22) PCT Filed: Oct. 5, 2005
(86) PCT No.: PCT/GB05/03820

§ 371 Date: Oct. 2, 2007

(30) Foreign Application Priority Data
Oct. 5, 2004 (GB) 0422086.9

(51) Int. Cl. G06F 9/44

(52) U.S. Cl. 719/310

(57) ABSTRACT

An interactive computing device is provided with a single step back navigation model. With the navigation model of the present invention only a single previous state that will be accessible with a BACK key or button on the device is remembered. This retains the ability for the user to be returned to the previous view in the original application when the chained task is completed.

This invention relates to an improved method of chaining applications on interactive computing devices.

The term interactive computing device should be construed to include any device which includes both a screen or other method for displaying information and also a keyboard, keypad, button array, touchscreen or some other method for input such as selecting information; today this includes personal devices such as desktop computer, laptop computers, Personal Digital Assistants (PDAs), Mobile Telephones, Smartphones, Digital Camera, Digital Music Players as well as many other industrial and domestic devices ranging from cash machines (ATMs) to domestic electrical apparatus (such as washing machines and televisions) to transport mechanisms including such devices, such as motor vehicles (of all forms), trains, boats and planes.

Many interactive computing devices are quite small in size, yet still supply their users with complex functionality and a full graphical user interface (GUI). Where such devices are resource-constrained, particularly as regards memory, it is very common for one application to rely on a second application for the provision of specific items of functionality; this is because memory constraints make it undesirable to duplicate functionality between applications.

It is therefore very common for users to chain applications and application views. Because of the memory constraints described above, applications typically run only in a single instance; this makes the task of navigating between applications which may have been invoked in long chains an area of some difficulty for the designer of the user interface.

Ideally, the navigational model in such devices should give the user an overview of and efficient access to the desired tasks.

One way to achieve this is to use a hierarchy with BACK operation; every time the user chains to a new application or enters a new view the old application or view is stacked. When the user wants to navigate to a different task several BACK operations must be done until the required task becomes available.

An alternative method is to ignore all previous states and always task away to new views. New views on applications are normally achieved in a number of ways, such as entering the start state with a single action (Home screen, Start button, Main Menu or Application Launcher) but they can also be invoked via an inter-process communication (IPC) action mechanism in a view.

A DNL is an example of such an IPC action mechanism; it is used to navigate directly from one application to another, usually to allow the user to carry out a task as easily as possible. They typically work in a particular context, taking data from one application and passing it to another application in order to allow the data to be used directly. For example, a DNL may be used in the contacts application on a telephone to allow the user to directly initiate a telephone call by selecting a telephone number.

DNLs are used extensively in the customizable UIQ user interface written by UIQ Technologies for Symbian OS, the advanced operating system from Symbian Software Ltd.

The problem with the first model described above is that it is very inefficient and inconvenient to a user to use all the BACK actions before starting a new task. Furthermore, as more functionality is put into the phone, the deeper the needed hierarchies become.

The problem with the stateless navigation model is that it provides a fast mechanism to enter new tasks, but in many cases there is a need to perform one task, perform an assisting task and then return to the original task.

It is, therefore, an object of the present invention to provide an improved navigation model in an interactive computing device.

According to a first aspect of the present invention there is provided a computing device in which:
a. multiple applications can be run; and
b. a first application can invoke a second application to perform a task; and
c. a link to the first application and a record of its state is saved before the second application is invoked to perform a task; and
d. both the first application and its state can be restored once the second application completes its task; unless
e. the second application has invoked a third application to perform a task, in which case
f. the link to the first application and its state is replaced with a link to the second application and a record of its state, and
g. both the second application and its state are restored once the third application completes its task, but
h. neither the first application nor its state are restored once the second application completes its task.

According to a second aspect of the present invention there is provided a method of operating a computing device in which:
a. multiple applications can be run; and
b. a first application can invoke a second application to perform a task; and
c. a link to the first application and a record of its state is saved before the second application is invoked to perform a task; and
d. both the first application and its state can be restored once the second application completes its task; unless
e. the second application has invoked a third application to perform a task, in which case
f. the link to the first application and its state is replaced with a link to the second application and a record of its state, and
g. both the second application and its state are restored once the third application completes its task, but
h. neither the first application nor its state are restored once the second application completes its task.

According to a third aspect of the present invention there is provided an operating system for causing a computing device of the first aspect to operate in accordance with a method of the second aspect.

Embodiments of the present invention will now be described, by way of further example only, with reference to the accompanying drawings, in which;

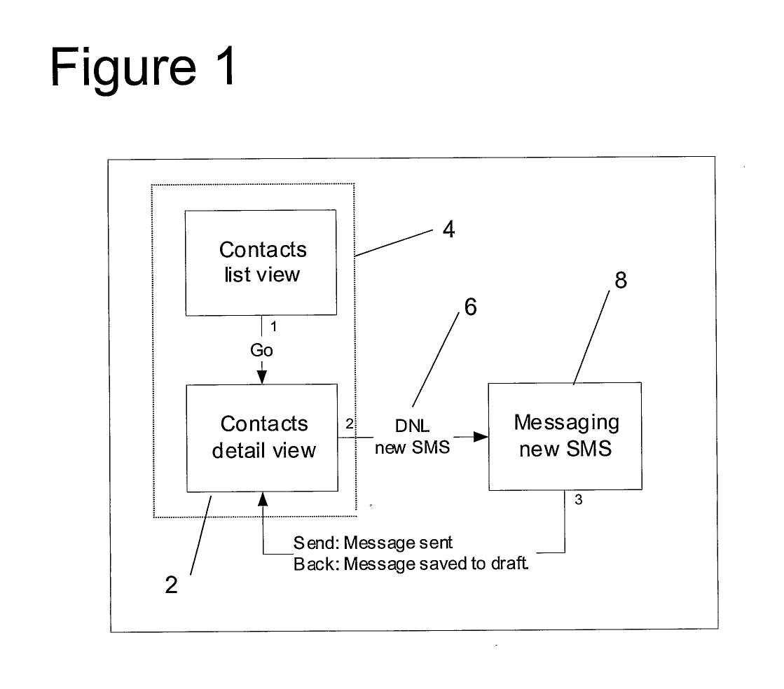

FIG. 1 shows the basic flow of the navigation model according to the present invention; and

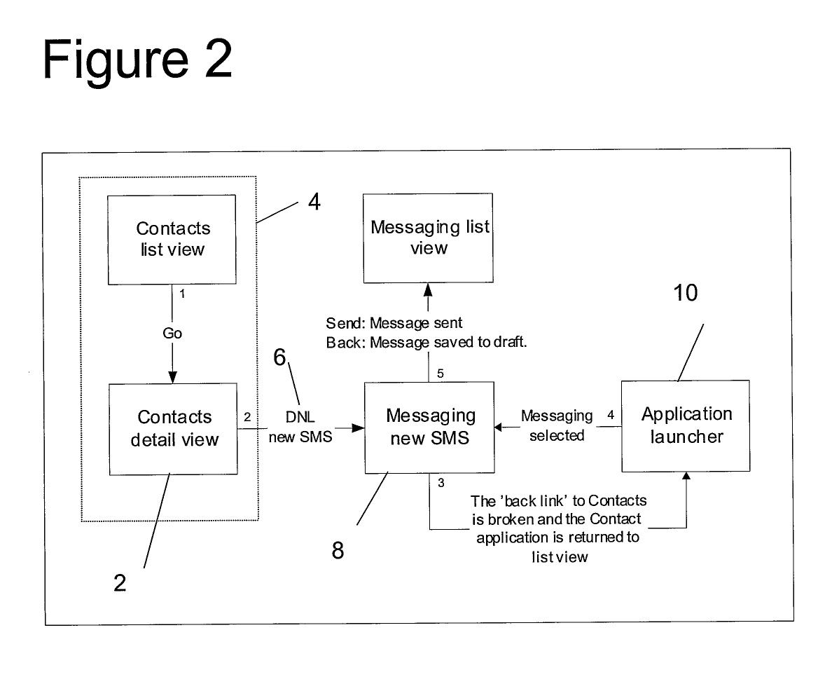

FIG. 2 shows the flow of the navigation model when the backlink has been broken.

With the navigation model of the present invention only a single previous state that will be accessible with a BACK key or button on the device is remembered. This retains the ability for the user to be returned to the original application when the chained task is completed. This is shown in FIG. 1, which depicts an interactive computing device in the form of a smartphone that is chained from a Contacts detail view 2 within a Contacts application via a DNL 6 to a Messaging application 8 in order to send an SMS. The navigation model only allows access to a single previous state, which in this case is to the contacts detail view 2 in the messaging application 4, as shown in FIG. 1. Hence if the BACK command is selected, the display of the device would return to the contacts detail view of the contacts application (i.e. single step back navigation) and not to the contacts list view of the Contacts application.

If, on the other hand, an application (app 1) is left in a specific state, for example, by navigating to a different application (app 2) by a dedicated button or via an application launcher such as a Main Menu or Start button, that specific state of app 1 is lost as soon as the different application (app 2) chains to a third application (app 3); in this case the original application (app 1) will always return to the base view. The BACK link to app 1 is therefore broken.

The BACK link to the original application (app 1) exists as long as the use case that the application chaining was intended to achieve remains valid. However, the use case is invalidated once the user tasks away from the application that was chained to (app 2); this means that the BACK link to the original application (app 1) is broken.

This navigation behavior means that BACK functionality only exists to one level. For example, as shown in FIG. 2, if a smartphone is chained from the Contacts detail view of its Contacts application via a DNL to the Messaging application (to send an SMS for example in a similar manner as described in relation to FIG. 1) and an application launcher 10 or main menu is then opened from the Messaging view, this would break the back link to the Contacts application. Hence, the Contacts application is then returned to its base Contacts list view the next time it is invoked (because the BACK link is broken) and not to the Contacts detail view (as was the case for the example described in relation to FIG. 1 when the back link had not been broken).

This invention describes therefore a method of restricting the reverse navigation of complex chains of execution in computing devices capable of running multiple applications to a single level and provides several advantages over the known art. This invention combines fast and efficient access to a new task with the ability to return to a previous task without inadvertently building up long application chains; long application chains make navigating between applications complex and unpredictable.

Although the present invention has been described with reference to particular embodiments, it will be appreciated that modifications may be effected whilst remaining within the scope of the present invention as defined by the appended claims.

1. A computing device in which:
a. multiple applications can be run; and
b. a first application can invoke a second application to perform a task; and
c. a link to the first application and a record of its state is saved before the second application is invoked to perform a task; and
d. both the first application and its state can be restored once the second application completes its task; unless
e. the second application has invoked a third application to perform a task, in which case
f. the link to the first application and its state is replaced with a link to the second application and a record of its state, and
g. both the second application and its state are restored once the third application completes its task, but
h. neither the first application nor its state are restored once the second application completes its task.

2. A method of operating a computing device in which:
a. multiple applications can be run; and
b. a first application can invoke a second application to perform a task; and
c. a link to the first application and a record of its state is saved before the second application is invoked to perform a task; and
d. both the first application and its state can be restored once the second application completes its task; unless
e. the second application has invoked a third application to perform a task, in which case
f. the link to the first application and its state is replaced with a link to the second application and a record of its state, and
g. both the second application and its state are restored once the third application completes its task, but
h. neither the first application nor its state are restored once the second application completes its task.

3. An operating system for causing a computing device according to claim 1 to operate in accordance with a method in which:
a. multiple applications can be run; and
b. a first application can invoke a second application to perform a task; and
c. a link to the first application and a record of its state is saved before the second application is invoked to perform a task; and
d. both the first application and its state can be restored once the second application completes its task; unless
e. the second application has invoked a third application to perform a task, in which case
f. the link to the first application and its state is replaced with a link to the second application and a record of its state, and
g. both the second application and its state are restored once the third application completes its task, but
h. neither the first application nor its state are restored once the second application completes its task.
